(19) United States
(12) Patent Application Publication
(10) Pub. No.: US 2007/0294753 A1
(43) Pub. Date: Dec. 20, 2007

(54) ADAPTOR OR IC CARD FOR ENCRYPTED COMMUNICATION ON NETWORK

(76) Inventors: Akira Tanaka, Kawasaki (JP); Masataka Okayama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/757,443

(22) Filed: Jun. 4, 2007

(30) Foreign Application Priority Data
Jun. 5, 2006 (JP) 2006-155615

(51) Int. Cl. H04L 9/32

(52) U.S. Cl. 726/9; 713/168; 380/229; 340/5.8

(57) ABSTRACT

An adaptor connected to a network to conduct encrypted communication includes a storage section for storing connection policy information to determine a communication method between a first communication apparatus and a second communication apparatus, a communication selecting section for determining a communication method using the connection policy information, an encrypted communication section for conducting, if encrypted communication is determined, encryption or decryption of communication data between the communication apparatuses, an external storage medium information reader section for reading information recorded in an external storage medium, and an external information control section for obtaining, if connection of an external storage medium is detected, connection policy information stored in the external storage medium and storing the connection policy information in the storage section.

### INCORPORATION BY REFERENCE

The present application claims priority from Japanese application JP2006-155615 filed on Jun. 5, 2006, the content of which is hereby incorporated by reference into this application.

### BACKGROUND OF THE INVENTION

The present invention relates to a technical field in which for example, an outdoor appliance accesses a home network connected to indoor appliances such as a Hard Disk Drive (HDD) recorder and a lighting apparatus to safely communicate with an indoor appliance and a ciphered communication is conducted between a Personal Computer (PC) in an in-house network of a firm and a printer as well as a Web server.

Recently, family Audio-Visual (AV) appliances such as a digital Television (TV) and a Digital Versatile Disk (DVD)/HDD recorder, white family electric appliances such as air conditioners and lighting apparatuses, and home appliances and apparatuses such as an electric door lock and various sensors are configured in a network, and construction of home networks is being developed by connecting these appliances to each other. Additionally, spread of network services using these appliances are expected.

However, when these appliances are configured in a network, an external appliance may easily access an appliance connected to the home network, and hence it is required to take measures against accesses such as an unauthorized access from an external appliance and an impersonation attack from an external appliance. Particularly, in the appliances used for a home security service such as an electric door lock and various sensors, an unauthorized access from an appliance outside the home network possibly causes a considerable accident and damage, and hence measures against the unauthorized accesses and the like are important.

On the other hand, also in a firm, a problem of information leakage due to an intentional or wrong use has been increasingly revealed, and measures against the problem are a pressing need also in an in-house network of the firm.

As a security communication method to prevent the unauthorized access and the information leakage, there is generally employed a Virtual Private Network (VPN) in which a virtual network is constructed on a public network by combining appliance authentication and encrypted data communication.

Also, there exists a configuration wherein home appliances in which it is difficult, since processing performance and the main storage and the external storage are insufficient as compared with a PC, to mount an appliance authentication function and an encrypted communication function having high processing load and appliances to which it is difficult to add a new function due to configurations such as a printer and an application server are applied as communication terminals to the VPN by use of an operation in which the encrypted communication between communication terminals are substitutionally conducted by network connection apparatuses such as a router.

In the VPN, a security level (an encryption algorithm, a key length, an authentication algorithm, and the like used in the encrypted communication between communication terminals) between communication terminals is designated to prescribe the encrypted communication in the unit of the communication terminal. However, patent document 1 (JP-A-2001-298449 (corresponding to US 2001/0042201 A1)) discloses a method wherein in the VPN configuration in which the encrypted communication between communication terminals are substitutionally conducted by network connection apparatuses such as a router, information of user who uses the communication terminal is related to a combination table of combinations between communication destinations and security levels to be held in the network connection apparatus such that according to user information from the communication terminal, the combination table is changed to set a communication security level to each user.

### SUMMARY OF THE INVENTION

However, according to the method described in patent document 1, it is required for the network connection apparatus connected to the communication terminal to keep, for the users who possibly use the communication terminal, all security combination tables (communication destinations, security levels) corresponding to the user information. That is, any user not existing in the corresponding information held by the network connection apparatus cannot communicate with an external communication terminal by use of a communication terminal. In the known example, there is described a method wherein it is not required to hold the corresponding information for all users by use of a scheme to issue a query to a server device which manages in a centralized way the user information and the security combination tables when the network connection apparatus receives communication data from a communication terminal used by the user not existing in the corresponding information. However, if the number of external apparatuses (communication terminals) with which the communication terminal is to communication is increased, there occurs a job to sequentially update the corresponding information managed in a centralized way.

Furthermore, to identify the user of the communication terminal, the communication terminal notifies user information to the network connection apparatus. However, since consideration has not been given to security such as the apparatus authentication and encryption of the user information, the pretense of the communication terminal and the takeover of the communication terminal are possible through wiretapping of the user information, changing of connection between appliances, or the like. This resultantly allows an unauthorized access to an external appliance as the connection destination depending on cases.

The present invention has been devised in consideration of the above problems, and an aspect thereof is to provide an inter-appliance communication technique applicable also to appliances in which ciphered communication processing cannot be installed, the technique allowing an operation to set a communication method (security policy) for each user of a communication terminal in association with authentication of the user to secure high safety.

Specifically, for example, the network connection apparatus (adaptor) to substitutionally conduct the encrypted communication of the communication apparatus includes a communication selecting section for determining a communication policy by use of the connection policy information to set a communication method of communication between the communication apparatus directly connected to the adaptor and an external communication apparatus connected via the network, an encrypted communication section for encrypting communication data to transmit the communication data to the eternal communication apparatus, and an IC card reader section for obtaining the connection policy and authentication information from an IC card.

After conducting authentication using the authentication information obtained from the IC card, if the communication control section determines, according to the connection policy information, that the communication between the communication apparatuses is encrypted communication, the encrypted communication section encrypts the communication data to transmit the communication data to the external communication apparatus.

Also, the Integrated Circuit (IC) card is configured to record authentication information of the user of the communication apparatus and the connection policy related to the user. As a result, the communication policy between the communication apparatuses can be set in association with the authentication for each user related to the IC card and there may be implemented inter-appliance communication with high safety.

According to the above configuration, for example, in an appliance in which the ciphered communication processing cannot be installed, there may be implemented highly safe inter-appliance communication in which the communication policy can be set in association with authentication for each user using the appliance.

Other objects, features and advantages of the invention will be come apparent from the following description of the embodiments of the invention taken in conjunction with the accompanying drawings.

### BRIEF DESCRIPTION OF THE DRAWINGS

FIG. 1 is a functional configuration diagram of an adaptor according to an embodiment.

FIG. 2 is a general configuration diagram of a communication system according to an embodiment.

FIG. 3 is a hardware configuration diagram of an information processing apparatus according to an embodiment.

FIG. 4 is a diagram to explain a data layout of a connection policy database according to an embodiment.

FIG. 5 is a diagram to explain a data layout of an encrypted communication information database according to an embodiment.

FIG. 6 is a flowchart of apparatus access start processing according to an embodiment.

FIG. 7 is a flowchart of communication execution start processing according to an embodiment.

FIG. 8 is a flowchart of data communication processing according to an embodiment.

FIG. 9 is a flowchart of data communication end processing according to an embodiment.

FIG. 10 is a flowchart of apparatus access end processing according to an embodiment.

FIG. 11 is a flowchart of apparatus access end processing according to an embodiment.

### DESCRIPTION OF THE EMBODIMENTS

Next, referring to the accompanying drawings, description will be given of an embodiment according to the present invention.

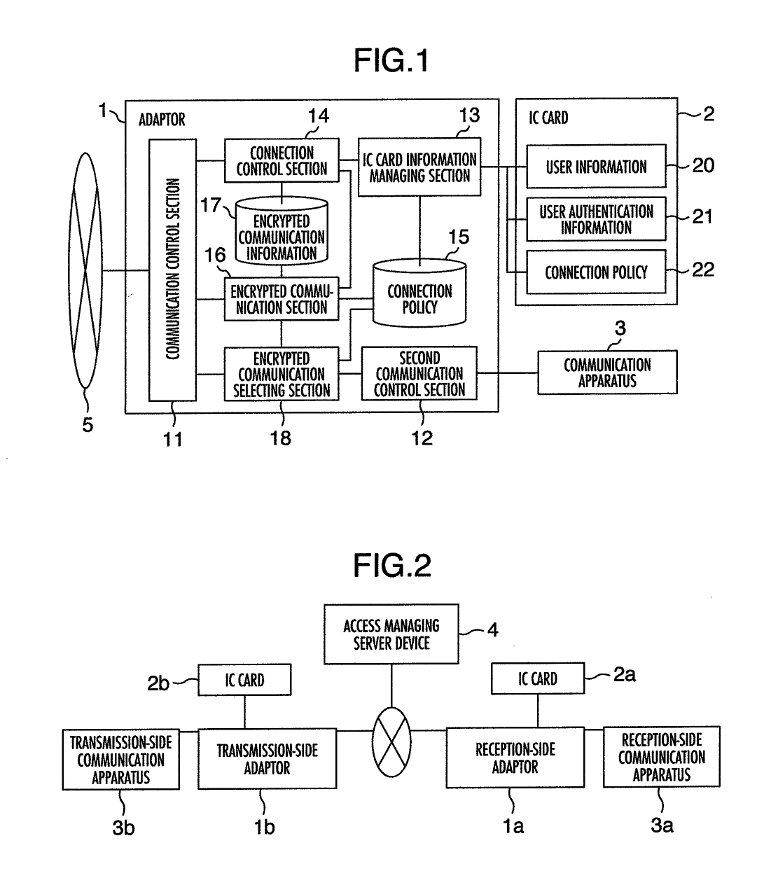

First, description will be given of a configuration of an adaptor according to the embodiment. As FIG. 1 shows, the adaptor 1 is configured to be connected via a communication medium 5 to an external communication apparatus, and is directly connected to a communication apparatus 3. Also, the adaptor 1 can read information storing in an IC of the IC card 2.

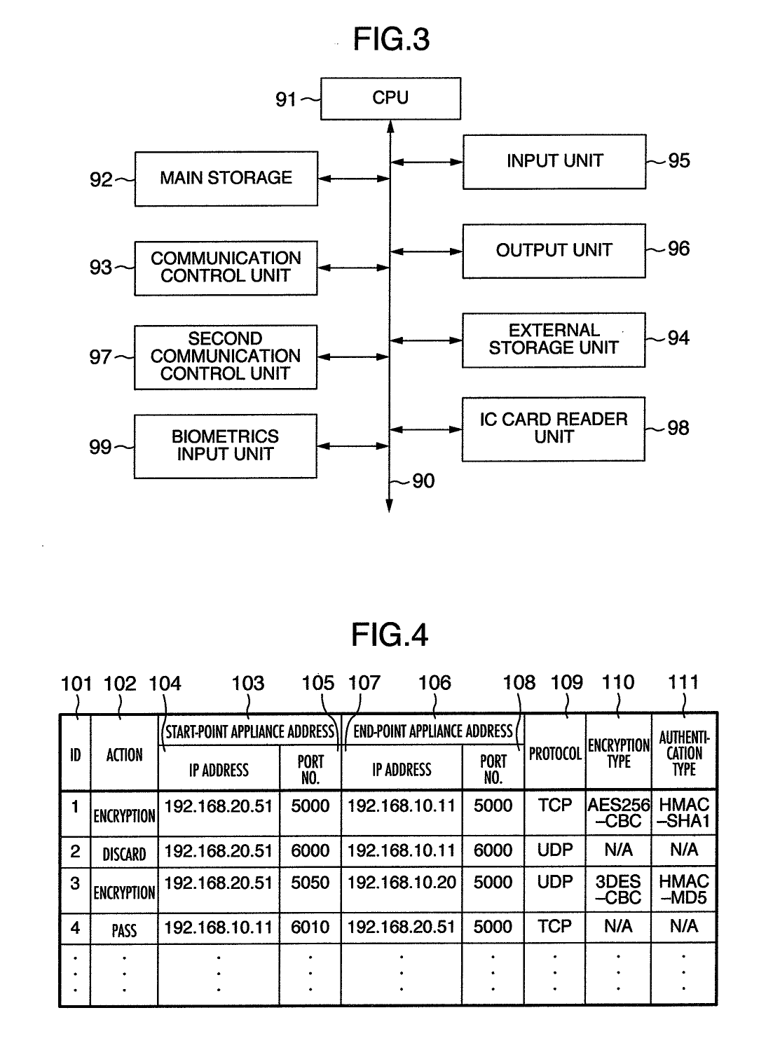

The adaptor 1 shown in FIG. 1 may be implemented by an information processing apparatus including an ordinary hardware configuration capable of executing software. Specifically, as FIG. 3 shows, the adaptor 1 includes a Central Processing Unit (CPU) 91, a main storage 92, a communication control unit 93, an external storage unit 94, an input unit 95, a second communication control unit 97, an IC card reader unit 98, and a biometrics input unit 99; and the respective units are mutually connected via a bus 99 to each other so that the respective units communicate required information with each other.

The CPU 91 conducts predetermined operations according to programs beforehand stored in the main storage 92 and the external storage unit 94. The main storage 92 is a unit which functions as a work area and which stores required programs; for example, the former is implementable using a Random Access Memory (RAM) and the latter is implementable using a Read Only Memory (ROM) or the like.

The communication control unit 93 is a unit to communicate information (data) via the communication medium 5 with an apparatus connected to the communication medium 5 and is implemented using, for example, a modem, a network adaptor, a radio transceiver, and the like.

The external storage unit 94 is a unit which saves programs to control operation of the information processing apparatus and which stores contents distributed via a communication medium, and is implementable using, for example, a hard disk (HDD), an optical disk, and the like.

The input unit 95 is a unit for the apparatus user to input required instructions and required information to the information processing apparatus, and is implementable using, for example, a remote controller used for a TV receiver and a keyboard and a mouse used for a PC.

The output unit 96 is a unit to output and to display contents and information to respond to an operation of the apparatus user, and is implementable using a Braun tube, a Cathode-Ray Tube (CRT), a liquid-crystal display, a Plasma Display Panel (PDP), a projector, a speaker, a headphone, a lamp, a Light Emitting Diode (LED), and the like.

The second communication control unit 97 is a unit to communicate information (data) with the communication apparatus 3, and is implementable using, for example, a network adaptor, and a radio transceiver.

The IC card reader unit 98 is configured so that an IC card is inserted therein and is capable of reading user information (a password, fingerprint information, finger vein information, an electronic certificate, and the like) stored in the IC of the IC card. The biometrics input unit 99 is an apparatus to read biometrics (fingerprint information, finger vein information, and the like) of the user. Incidentally, the biometrics input unit 99 is not necessarily required.

Incidentally, the hardware configuration of the information processing apparatus shown in FIG. 3 is an example, and is not necessarily as shown in FIG. 3. For example, the output unit 96 may be implemented by an apparatus (a television or the like); and in this case, the information processing apparatus additionally includes a television signal generating apparatus such as a Digital-to-Analog (D/A) converter and the television signal generating apparatus is connected to the output unit 96 via an AV cable, a coaxial cable, or the like.

Of the units constituting the information processing apparatus, any unit not directly related to the input and output operations of data and programs may be dispensed with. For example, if the information processing apparatus does not require data input and output operations at execution, it is possible that the configuration may not include the input unit 95 and the output unit 96.

Although the second communication control unit 97, the IC card reader unit 98, and the biometrics input unit 99 are included in the adaptor 2, these units may not be included in other information processing apparatuses.

Also, the communication apparatus 3 shown in FIG. 1 may be implemented by an information processing apparatus including an ordinary hardware configuration capable of executing software, specifically, has the hardware configuration shown in FIG. 3 except the second communication control unit 97, the IC card reader unit 98, and the biometrics input unit 99.

Next, description will be given of a configuration of a communication system according to the embodiment. As FIG. 2 shows, the communication system according to the embodiment includes a transmission-side adaptor 1a, a reception-side adaptor 1b, and an access managing server device 4 which are connected via the communication medium 5 to each other; a transmission-side communication apparatus 3a and a transmission-side IC card 2a connected to the transmission-side adaptor 1a, and a reception-side communication apparatus 3b and a reception-side IC card 2b connected to the reception-side adaptor 1b.

Here, the transmission-side adaptor 1a and the reception-side adaptor 1b correspond to the adaptor 1 according to the embodiment shown in FIG. 1, the transmission-side communication apparatus 3a and the reception-side communication apparatus 3b correspond to the communication apparatus 3 connected to the adaptor 1 shown in FIG. 1, and the IC card 2a and the IC card 2b correspond to the IC card 2 connected to the adaptor 1 shown in FIG. 1.

Furthermore, in FIG. 2, one of the adaptors corresponding to the adaptor 1, one of the IC cards corresponding to the IC card 2, and one of the communication apparatuses 3 are represented as “reception-side” devices and the other ones respectively thereof are represented as “transmission-side” devices for convenience of explanation. However, the respective devices are of the same configuration and the functions thereof are not different from each other between “reception-side” and “transmission-side”. That is, an operation on “reception-side” may be conducted on “transmission-side” and vice versa.

Incidentally, the access managing server device 4 included in the communication system shown in FIG. 2 is implementable using an information processing apparatus including an ordinary hardware configuration capable of executing software, and specifically has the hardware configuration shown in FIG. 3 except the second communication control unit 97, the IC card reader unit 98, and the biometrics input unit 99.

Additionally, the communication medium 5 included in the configuration of the adaptor shown in FIG. 1 and in the communication system shown in FIG. 2 is a public communication network or a leased communication network configured using an optical communication line, a Community Antenna TeleVision (CATV), a wired medium configured using a telephone line and the like, or a wireless medium, or an Local Area Network (LAN) in a network in a house or a network in a firm configured using a communication cable, a power-transmission line, a wired medium configured using a telephone extension line, and the like, or a wireless medium. The communication medium 5 enables data communication according to a predetermined communication protocol between the apparatuses connected to the communication medium 5.

Next, description will be given of functions and a database configuration implemented through execution of software by the adaptor 1 (transmission-side adaptor 1a, reception-side adaptor 1b), the IC card 2 (transmission-side IC card 2a, reception-side IC card 2b), the communication apparatus 3 (transmission-side adaptor 3a, reception-side adaptor 3b), and the access managing server device 4 shown in FIGS. 1 and 2.

The adaptor 1 (reception-side adaptor 1b) is an information processing apparatus which receives a connection instruction information via the access managing server device 4 from the adaptor (transmission-side adaptor 1a) opposing in communication to the adaptor 1 and which mediates, based on the connection instruction information, peer-to-peer communication between the communication apparatus (transmission-side communication apparatus 3a) connected to the opposing adaptor and the communication apparatus 3 (reception-side communication apparatus 3b) connected to the adaptor 1.

The adaptor 1 includes, as FIG. 2 shows, a communication control section 11, a second communication control section 12, an IC card information managing section 13, a connection control section 14, an encrypted communication section 16, and an encrypted communication selecting section 18. The main storage 92 or the external storage unit 94 of the adaptor 1 beforehand stores an encrypted communication information database 17 and a connection policy database 15.

For the connection control section 14, the encrypted communication section 16, and the encrypted communication selecting section 18 to communicate with the apparatuses (the access managing server device 4, the opposing adaptor) connected to the communication medium 5, the communication control section 11 includes a function to create, to interpret, and to communicate a message according to a communication protocol.

For the encrypted communication selecting section 18 to communicate with the communication apparatus 3, the second communication control section 12 includes a function to create, to interpret, and to communicate a message according to a communication protocol.

The IC card information managing section 13 includes a function to read an electronic certificate 21 from the IC card 2 using the IC card reader unit 98, a function to read connection policy information 22 from the IC card 2 using the IC card reader unit 98, and a function to store the connection policy information in the connection policy database 15.

The connection control section 14 includes a function to connect via the communication control section 11 to the access managing server device 4, a function to receive from the access managing server device 4 service connection instruction information from the opposing adaptor (transmission-side adaptor 1a), and a function to transmit to the access managing server device 4 address information required to conduct data communication with the opposing adaptor (transmission-side adaptor 1a).

The connection policy database 15 is a database to manage information to determine communicability (communication method) between the communication apparatus 3 connected to the adaptor 1 and the opposing communication apparatus. As FIG. 4 shows, a policy IDentifier (ID) 101, an action 102, a start point appliance address 103 (an Internet Protocol (IP) address 104, a port number 105), an end point appliance address 106 (an IP address 107, a port number 108), a protocol 109, an encryption type 110, and an authentication type 111 are registered to the connection policy database 15.

Information to identify a connection policy (items 102 to 111) indicating communicability between the communication apparatuses is set to the policy ID 101. Information of “encryption”, “pass”, or “discard” is set to the action 102. The encrypted communication selecting section 18 and the encrypted communication section 16 execute processing for communication matching the contents of the setting (communication for which the start point appliance address 103, the end point appliance address 106, and the protocol 109 match) according to the contents of the action 101.

In an operation to receive data transmitted from the communication apparatus 3 connected to the adaptor 9 to the opposing communication apparatus, if the contents of setting to the action 101 is “encryption”, the encrypted communication selecting section 18 receives transmission data via the second communication control section 12 from the communication apparatus 3. To conduct encrypted communication according to the contents of the setting to the action 101, the encrypted communication selecting section 18 passes the transmission data to the encrypted communication section 16. The encrypted communication section 16 obtains encrypted communication information corresponding to the communication from the encrypted communication information database 17 to encrypt the transmission data and then transmits the data via the communication control section 11 to the opposing communication apparatus.

When receiving the communication data from an opposing communication apparatus or from an adaptor substitutionally conducting communication of the opposing communication apparatus, the encrypted communication section 16 receives the communication data via the communication control section 11 from the opposing communication apparatus, obtains encrypted communication information corresponding to the communication from the encrypted communication information database 17, and decrypts the received data and then passes the data to the encrypted communication selecting section 18. The encrypted communication selecting section 18 transmits the data via the second communication control section 12 to the communication apparatus 3.

Incidentally, if the communication data from the opposing communication apparatus has not been encrypted or cannot be correctly decrypted according to the encrypted communication information, the encrypted communication selecting section 18 discards the received data. That is, the received data is not transmitted to the communication apparatus 3 connected to the adaptor 3.

When receiving the data transmitted from the communication apparatus 3 connected to the adaptor 9, if the contents of the setting in the action 101 is “pass”, the encrypted communication selecting section 18 receives transmission data via the second communication control section 12 from the communication apparatus 3 and directly transmits the data via the communication control section 11 to the opposing communication apparatus. Also, when receiving communication data from the opposing communication apparatus, the encrypted communication selecting section 18 receives transmission data via the communication control section 11 from the opposing communication apparatus and directly transmits the data via the second communication control section 12 to the communication apparatus 3.

When receiving the data transmitted from the communication apparatus 3 connected to the adaptor 9 to the opposing communication apparatus, if the contents of setting to the action 101 is “discard”, the encrypted communication selecting section 18 receives transmission data via the second communication control section 12 from the communication apparatus 3 and then discards the transmission data (data transmission to the opposing communication apparatus). Also, when receiving communication data from the opposing communication apparatus, the encrypted communication selecting section 18 discards data (data reception from the opposing communication apparatus) received via the communication control section 11. That is, the communication data is not transmitted.

The appliance address of the communication apparatus as the communication start point which is an applied condition of the connection policy is registered to the start point appliance address 103. In the case of IP communication, the start point appliance address 103 includes an IP address 104 and a port number 105, and an IP address of a communication apparatus as the communication start point is registered to the IP address 104, and a transmission port number of the communication apparatus as the communication start point is registered to the port number 105.

The appliance address of the communication apparatus as the communication end point which is an applied condition of the connection policy is registered to the end point appliance address 106. In the case of IP communication, the end point appliance address 106 includes an IP address 107 and a port number 108, and an IP address of a communication apparatus as the communication end point is registered to the IP address 107, and a transmission port number of the communication apparatus as the communication end point is registered to the port number 108.

A protocol type of communication which is an applied condition of the connection policy is registered to the protocol 109. For example, a communication protocol such as Transmission Control Protocol (TCP) or User Datagram Protocol (UDP) is designated.

The encryption algorithm in communication to which the connection policy is applied is set to the encryption type 110. That is, there is registered an encryption method of the encrypted communication to protect communication with which the start point appliance address 103, the end point appliance address 106, and the protocol 109 match. For example, an encryption method such as AES256-CBC (Advanced Encryption Standard method, 256-bit encryption key size, Cipher Block Chaining mode) is designated.

The message authentication algorithm in the encrypted communication of communication to which the connection policy is applied is set to the authentication type 111. That is, there is registered an authentication method to authenticate authenticity of the encrypted communication to protect communication with which the start point appliance address 103, the end point appliance address 106, and the protocol 109 match. For example, a message authentication method such as Keyed-Hashing for Message Authentication code/Secure Hash Algorithm 1 (HMAC-SHA1) is designated.

In the example of the connection policy database 15 shown in FIG. 4, the contents of the first entry (item of policy ID=“1”) means that when a transmission-side communication apparatus having an IP address of “192.168.20.51” conducts communication by use of a port number of “5000” to a port number of “5000” of a reception-side communication apparatus having an IP address of “192.168.10.11”, an encryption algorithm of “AES256-CBC” and an authentication algorithm of “HMAC-SHA1” are applied between a transmission-side adaptor and a reception-side adaptor which substitutionally conduct communication of the respective communication apparatuses to conduct encryption for the communication.

Incidentally, in the communication not matching with the contents of setting in the connection policy database 15 (the communication with which the start point appliance address 103, the end point appliance address 106, and the protocol 109 do not match), it is only required to beforehand determine a default action (either one of “encryption”, “pass”, and “discard”).

The encrypted communication section 16 includes a function to obtain encryption information (including an encryption method, an encryption key, and the like) required for the encryption and the decryption of communication data in peer-to-peer data encrypted communication with the opposing adaptor (the adaptor to substitutionally conduct communication of the opposing communication apparatus) by use of the connection control section 14 and to set the encryption information to the encrypted communication information database 17; a function to decrypt, according to the encryption information set to the encrypted communication information database 17, the communication data received via the communication control section 11 from the opposing adaptor and to pass the data to the encrypted communication selecting section 18; and a function to encrypt, according to the encryption information set to the encrypted communication information database 17, the transmission data to the opposing communication apparatus passed from the selecting section 18 and to transmit the data via the communication control section 11.

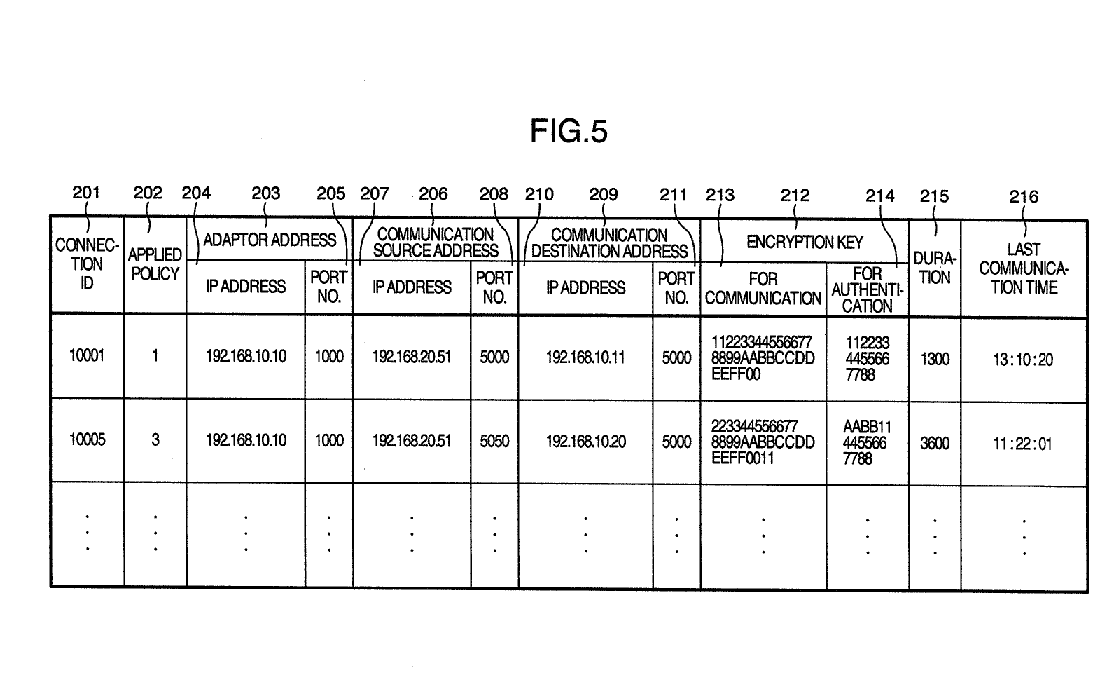

The encrypted communication information database 17 is a database to manage address information and encryption information (including an encryption method, an encryption key, and the like) required for the encryption and the decryption of communication data in the peer-to-peer data encrypted communication. The database 17 holds, as FIG. 5 shows, a connection ID 201, an applied policy 202, an adaptor address 203 (IP address 204, port number 205), a communication source address 206 (IP address 207, port number 208), a communication destination address 206 (IP address 210, port number 211), an encryption key 212 (for communication 213, for authentication 214), a duration 215, and a last communication time 216.

A code to identify the encrypted communication information is set to the connection ID 201. The policy ID 101 of the connection policy database 15 corresponding to the connection policy applied to the data encrypted communication is set to the applied policy 202. That is, when obtaining the encrypted communication information, a search is made through the policy database 15 using the policy ID set to the applied policy 202 to obtain the encryption type 110 and the authentication information 111.

Incidentally, the encryption type and the authentication information may also be held in place of the connection policy 202. In this case, when registering the encryption information of communication to the encryption information database, the encryption type 110 and the authentication information 111 are registered, not the policy ID 101 in the connection policy database 15 of the connection policy applied to the communication.

The appliance address of the opposing adaptor (the adaptor to substitutionally conduct communication of the opposing communication apparatus) as the communication destination of the peer-to-peer data encrypted communication is registered to the adaptor address 203. The adaptor address 203 includes the IP address 204 and the port number 205, and the IP address of the communication destination adaptor is registered to the IP address 204 and the reception port number of the communication destination adaptor is registered to the port number 205.

The appliance address of the communication apparatus 3 connected to the adaptor 1 is registered to the communication source address 206. The communication source address 206 includes the IP address 207 and the port number 208, and the IP address of the communication apparatus is registered to the IP address 207 and the reception port number of the communication apparatus is registered to the port number 208.

The appliance address of the communication apparatus (opposing communication apparatus) as the communication destination of the communication apparatus 3 is registered to the communication destination address 209. The communication destination address 209 includes the IP address 210 and the port number 211, and the IP address of the opposing communication apparatus is registered to the IP address 210 and the reception port number of the opposing communication apparatus is registered to the port number 211.

Information of an encryption key of the communication data in the peer-to-peer data encrypted communication is set to the encryption key 212. The encryption key 212 includes “for communication” 213 and “for authentication” 214, and the encryption key in the peer-to-peer data encrypted communication is registered to the “for communication” 213 and the encryption key of the message authentication in the peer-to-peer data encrypted communication is registered to the “for authentication” 214.

The duration of the peer-to-peer data encrypted communication is set to the duration 215. The last time when the peer-to-peer data encrypted communication is conducted is set to the last communication time 216. The duration 215 and the last communication time 216 are used as a trigger to delete the encrypted communication information of the encrypted communication in which a no-communication state continues for a fixed period of time, and are not necessarily required for the configuration of the adaptor 1 in which the encrypted communication information is not deleted.

The encrypted communication selecting section 18 includes a function to hold the appliance address information of the communication apparatus 3 connected to the adaptor 1, a function to determine, on the basis of the contents of the connection policy held in the connection policy database 15, a communication method (communicability and possibility of encryption) between the communication apparatus 3 connected to the adaptor 1 and the opposing communication apparatus; and a function to mediate data communication between the connected communication apparatus 3 and the opposing communication apparatus.

The IC card 2 is a known IC card in which an IC chip to record information is buried. The IC card 2 includes a general function of the IC card, namely, a function to encrypt and hold information in the IC, a function to externally conduct read and write operations of information in the IC by use of an IC card reader (such as the IC card reader unit 98 of the adaptor 1) in a contact method (the information in the IC is fed via a contact point installed in the card) or a contactless method (using a radio wave), and a function to allow the reading of the information held in the IC by an IC card reader only if information of a user having the IC card read right is notified.

The IC card 2 includes user information 20, user authentication information 21, and connection policy information 22.

Information to identify a user related to the IC card, namely, information to determine a user who is allowed to read the information in the IC is registered to the user information 20. Examples of the user information are a password and biometrics such as fingerprint information, and a finger vein information. The user information 20 may include user information items of these plural schemes.

Authentication information of a user related to the IC card, namely, authentication information of a user employed in the appliance authentication (authentication of a user who uses the appliance) in the access managing server device 4 is registered to the user authentication information 21. An example of the authentication information is a user's unique ID capable of identifying the user, a combination of a user's unique ID and a password, or an electronic certificate based on Public Key Infrastructure (PKI).

Connection policy information of a user related to the IC card, namely, information to determine the security communication method (communicability and possibility of encryption) between the communication apparatus 3 employed by the user and an external communication apparatus is registered to the connection policy information 22. The information registered to the connection policy information 22 includes the same items as for the connection policy database 15 of the adapter 1 shown in FIG. 4.

The communication apparatus 3 is an information processing apparatus including a function to communicate with other communication apparatuses. The communication apparatus 3 is connected to the adaptor 1, and communication with each external is conducted via the adaptor 1.

The access managing server device 4 is an information processing apparatus including a relay function such that in the communication between the communication apparatuses 3 connected to adaptor 1, when one of the communication apparatuses 3 (transmission-side communication apparatus 3a) starts communication with the opposing communication apparatus (reception-side communication apparatus 3b), the access managing server device 4 receives connection instruction information transmitted from the adaptor (transmission-side adaptor 1a) connected to the transmission-side communication apparatus 3a, retrieves the adaptor (reception-side adaptor 1b) corresponding (connected) to the opposing communication apparatus (reception-side communication apparatus 3b) indicated by the connection instruction information, and transmits the connection instruction information to the opposing adaptor (reception-side adaptor 1b).

The access managing server device 4 includes a communication control section to conduct a data transfer according to a communication protocol, an access authentication section to authenticate authenticity of the connection apparatus (the adaptor 1 in the embodiment), an access managing section to manage connection information of the connection apparatus, and an access relay section which retrieves a connection apparatus (the reception-side adaptor 1b) corresponding to the connection instruction information from the connection apparatus (the transmission-side adaptor 1a) and notifies the connection instruction information to the corresponding connection apparatus (the reception-side adaptor 1b). Additionally, the external storage unit of the access managing server device 4 stores an authentication information managing database to which authentication information of authorized users of the communication system is registered and a connection managing database to which connection information (apparatus identifying information, an appliance address, and the like) of the connection apparatuses is registered.

According to such functional configuration, after the access authentication section first authenticates connection of the adaptors, when the communication control section obtains connection instruction information from one of the adaptors (the transmission-side adaptor 1a), the access relay section retrieves by use of the access managing section the opposing adaptor (the reception-side adaptor 1b) as the connection destination from the access managing database to transfer the connection instruction information by use of the communication control section to the opposing adaptor (the reception-side adaptor 1b). Incidentally, as the communication protocol of the connection instruction information, there has been known Session Initiation Protocol (SIP) used in the IP telephone service, and SIP is also applicable to the access managing server device 4.

Next, description will be given of an outline of the encrypted communication execution processing executed in the communication system shown in FIG. 2 to implement safe communication between the communication apparatuses employed by authorized users. Here, description will be given of an example of a case in which the transmission-side communication apparatus 3a connects to the reception-side communication apparatus 3b to transmit communication data.

The encrypted communication execution processing includes apparatus access start processing (S1000) in which the adaptor 1 substitutionally conducting communication of the communication apparatus obtains, before the execution of communication between the communication apparatuses, connection policy information of the user using the communication apparatus 3. The adaptor 1 connects to the access managing server device 4 to register address information of the adaptor 1 required to transfer connection instruction information between the adaptors and to certify the authenticity of the user using the communication apparatus. The transmission-side adaptor 1a having received communication data transmitted from the transmission-side communication apparatus 3a transmits connection instruction information via the access managing server device 4 to the reception-side adaptor 1b to establish peer-to-peer communication between the communication apparatuses via the adaptors.

The encrypted communication execution processing is implemented by sequentially executing respective steps of data communication execution start processing to start data communication between the communication apparatuses (S2000), data communication processing to conduct data communication between the communication apparatuses via the adaptors (S3000), data communication end processing in which the transmission-side adaptor 1a having detected the end of data transmission from the transmission-side communication apparatus 3a to the reception-side communication apparatus 3b transmits connection end instruction information via the access managing server device 4 to the reception-side adaptor 1b to terminate the peer-to-peer communication between the communication apparatuses via the adaptors (S4000), and apparatus access end processing in which the adaptor 1 substitutionally conducting communication of the communication apparatus deletes the connection policy information of the user using the communication apparatus 3 not to accept notification from the access managing server device 4 (to disconnect from the access managing server device 4; S5000 or S5100).

Here, the data communication itself between the communication apparatuses is achieved only by executing respective steps of S2000, S3000, and S4000. Step S1000 is pre-processing of the data communication between the communication apparatuses and is executed at activation (setup) of the adaptor 1 or the like, Step S5000 or S5100 is post-processing of the data communication between the communication apparatuses and is executed, for example, when the user terminates the use of the communication apparatus 3.

Next, description will be given of details of the respective steps (S1000, S2000, S3000, S4000, S5000, S5100).

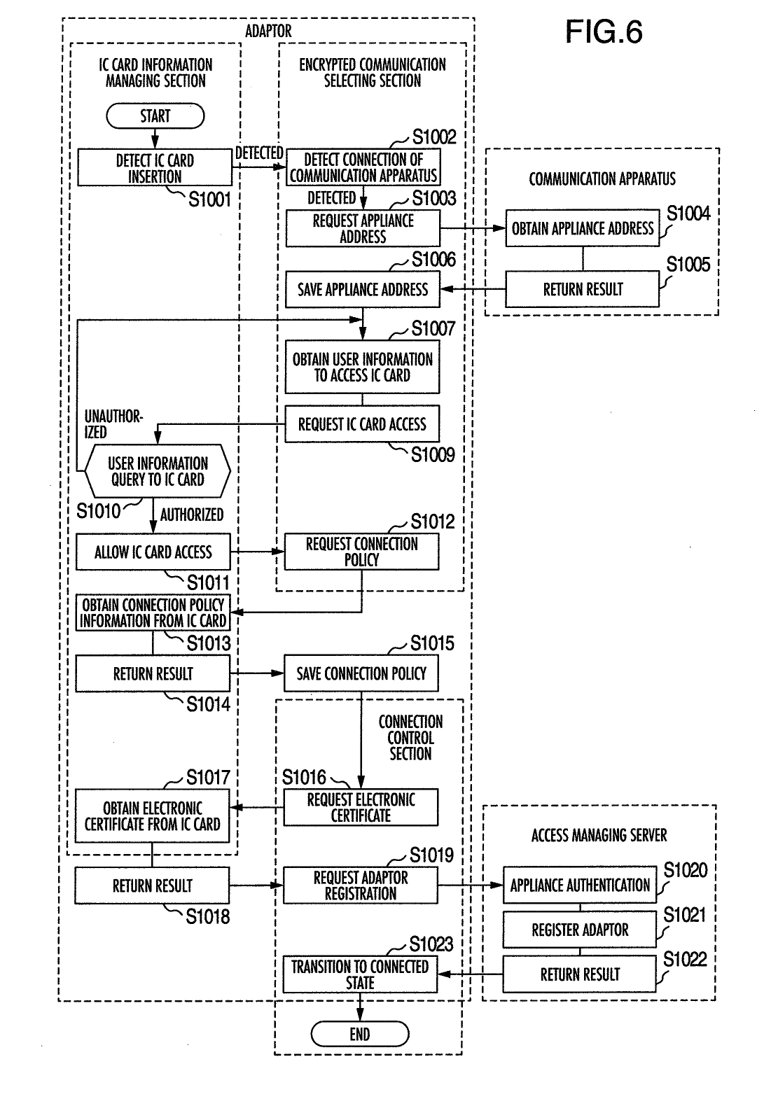

FIG. 6 shows a flowchart of processing executed in the apparatus access start processing (S1000). The IC card information managing section 13 of the adaptor 1 notifies to the encrypted communication selecting section 18 the detection of insertion of an IC card 2 in the IC card reader unit 98 installed in the adaptor 1 (S1001). The encrypted communication selecting section 18 of the adaptor 1 detects whether or not the adaptor 1 is in the communication connected state via the second communication control section 12 with the communication apparatus 3 according to, for example, an event that a connection cable between the adaptor 1 and the communication apparatus 3 has is inserted (S1002). If the connection is detected, the second communication control section 12 transmits an appliance address request to the communication apparatus 3 (S1003). The communication apparatus 3 obtains its own appliance address (S1004) and returns the result to the adaptor 1 (S1005). The encrypted communication selecting section 18 of the adaptor 1 holds the appliance address thus returned (S1006).

Next, the encrypted communication selecting section 18 of the adaptor 1 obtains user information to access information held in the IC of the IC card 2 (S1007). Here, the user information is information required to access an IC card such as biometrics inputted from the biometrics input unit 99 of the adaptor 1, a password and an identification code inputted by the user from the input unit 95 of the adaptor 1. Next, the encrypted communication selecting section 18 of the adaptor 1 notifies the user information to the IC card information managing section 13 to request IC card access allowance (S1009).

The IC card information managing section 13 sends the user information via the IC card reader unit 98 to the IC card 2 to make a query about possibility of access to the information in the IC of the IC card 2 (S1010). The IC card 2 makes a check for accessibility of the information in the IC based on the user information and the user information 20 held in the IC. If the access is not allowed, the encrypted communication selecting section 18 receives a message that the access is not allowed and then processing is repeatedly executed beginning at S1006. If the access is allowed, the encrypted communication selecting section 18 returns the IC card 2 access allowance to the encrypted communication selecting section 18 (S1011).

Next, the encrypted communication selecting section 18 of the adaptor 1 requests the IC card information managing section 18 to obtain the connection policy information 22 held in the IC of the IC card 2 (S1012). The IC card information managing section 18 obtains, via the access path to the information 22 in the IC of the IC card 2, the contents of the connection policy information 22 of the IC card 2 (S1013) and returns the obtained result to the encrypted communication selecting section 18 (S1014). The encrypted communication selecting section 18 registers the received connection policy information to the connection policy database 15 (S1015).

Next, the connection control section 14 of the adaptor 1 requests IC card information managing section 18 to obtain the user authentication information 21 held in the IC of the IC card 2 (S1016). The IC card information managing section 18 obtains, via the access path to the information in the IC of the IC card 2, the contents of the user authentication information 21 of the IC card 2 (S1017) and returns the obtained result to the encrypted communication selecting section 18 (S1018).

Here, an example of the user authentication information includes a unique user ID capable of identifying the user of the adaptor 1, a combination of the user ID and a password, a unique appliance ID capable of identifying the adaptor 1, or an appliance unique certificate based on Public Key Infrastructure (PKI).

Next, the connection control section 14 of the adaptor 1 creates an apparatus registration request including the user authentication information received from the IC card information managing section 18, the address information (appliance address) of the adaptor 1, and the address information (appliance address) of the communication apparatus 3 connected to the adapter 1 held in step S1006, and sends the request as connection instruction information to the access managing server device 4 (S1019).

Here, the address information of the adaptor 1 includes the IP address and the port number for the adaptor 1 to receive the notification from the access managing server device 4. Also, the address information of the communication apparatus 3 includes the IP address of the communication apparatus 3. The access managing server device 4 first searches the authentication information managing database for authentication information matching the authentication information included in the apparatus registration request from the adaptor 1, that is, executes authentication processing (S1020).

As a result, if the matching authentication information is absent, the access managing server device 4 assumes authentication failure and returns information indicating connection rejection to the adaptor 1. When the connection rejection information is received, the adaptor 1 executes processing, for example, to display on the output unit the failure in the connection to the access managing server device 4 and then terminates the apparatus access start processing.

On the other hand, if the authentication information matching that included in the apparatus registration request is present, the access managing server device 4 assumes authentication success and registers to the connection managing database the address information of the adaptor 1 and the communication 3 included in the apparatus registration request (S1021) and returns information indicating the connection success to the adaptor 1 (S1022).

After receiving the connection success information, the connection control section 14 of the adaptor 1 makes a transition to a state to wait for data such as connection instruction information transmitted from the access managing server device 4 (S1023). That is, the adaptor 1 is in a wait state in which data communication from the access managing server device 4 is monitored to operate, at reception of data, the connection control section 14 according to information included in the data.

Incidentally, the SIP is generally employed as the communication protocol including the apparatus registration request in the apparatus access start processing between the access managing server device 4 and the adaptor 1, and the apparatus registration request in the apparatus access start processing corresponds to a REGISTER request in SIP.

Incidentally, in the apparatus access start processing, the encrypted communication selecting section 18 of the adaptor 1 transmits an appliance address request to the communication apparatus 3 and then the communication apparatus 3 returns its own appliance address information to the encrypted communication selecting section 18 in steps S1002 to S1004. However, it is also possible that the encrypted communication selecting section 18 of the adaptor 1 monitors communication data from the communication apparatus 3 via the second communication control section 12 to obtain the appliance address of the communication apparatus 3 included in the communication data.

For example, the appliance address (IP address) of the communication apparatus 3 can be obtained using the source address included in an Internet Protocol (IP) packet. In this case, the processing in step S1002 is only the monitoring of communication data from the communication apparatus 3 and the appliance address extraction processing on the basis of the data, and the processing of the communication apparatus (steps S1003 and S1004) can be dispensed with.

Also, in the apparatus access start processing, the user information to access the IC card 2 is obtained by use of the input unit 95 or the biometrics input unit 99 of the adaptor 1 in step S1007. However, it is also possible that the communication apparatus 3 obtains and transmits the user information and the encrypted communication selecting section 18 of the adaptor 1 obtains the user information, that is, the user inputs the user information using the communication apparatus 3. In this case, the processing in step S1007 is the processing to transmit a user information request to the communication apparatus 3, and user information obtaining processing using the input unit 95 or the biometrics input unit 99 and processing to transmit user information to adaptor 1 are additionally installed in the communication apparatus 3.

Also, in the apparatus access start processing, the appliance address (IP address) of the communication apparatus 3 is included in the apparatus registration request to be transmitted to the access managing server device 4 in step 1019. However, it is also possible that the appliance address is notified as independent connection instruction information to the access managing server device 4, without including the appliance address in the apparatus registration request.

Also, in the apparatus access start processing, on the basis of the user authentication information from the adaptor 1, the access managing server device 4 conducts appliance authentication for the adaptor 1 in step S1020. However, it is possible to increase safety in the communication of the connection instruction information by conducting mutual authentication in which also the adaptor 2 authenticates the access managing server device 4. In this case, authentication information of the access managing server device 4 is included in the connection success information to be returned to the adaptor 1 to return the information to the adaptor 1 in step S1022 and verification processing (authentication processing) of the authentication information of the access managing server device 4 is added to step S1023.

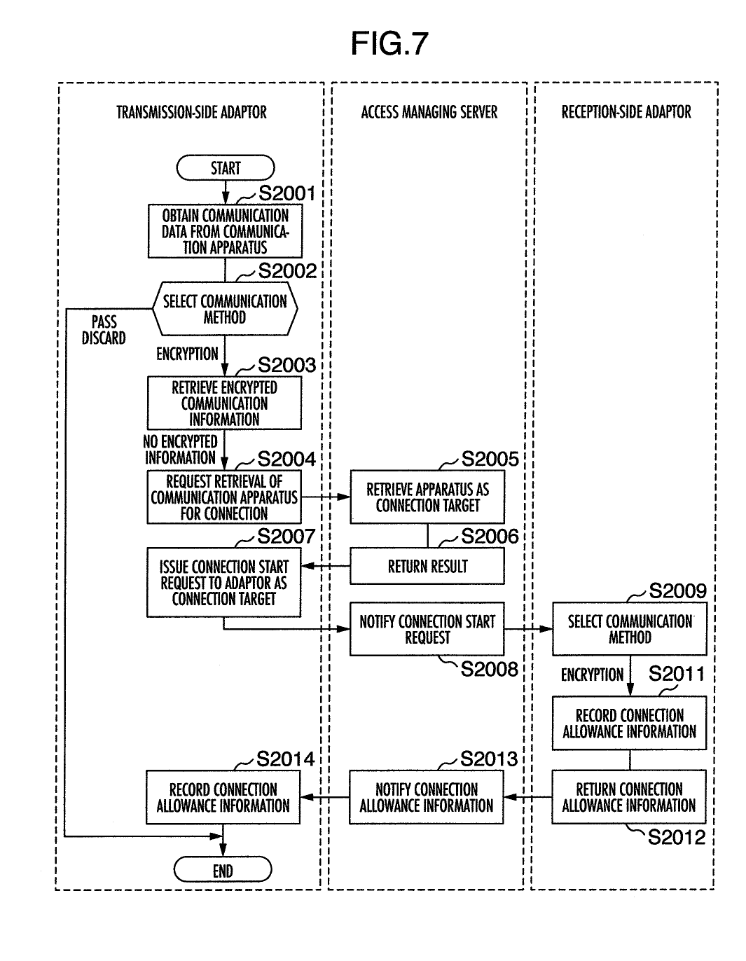

FIG. 7 shows a flowchart of processing executed in the data communication execution start processing (S2000). When the transmission-side communication apparatus 3a connected to the transmission-side adaptor 1a transmits communication data to the reception-side communication apparatus 3b (connected to the reception-side adaptor 1b), the encrypted communication selecting section 18 of the transmission-side adaptor 1a obtains the communication data via the second communication control section 12 (S2001). The encrypted communication selecting section 18 retrieves, from the connection policy database 15 held in the transmission-side adaptor 1a, connection policy information matching respective data extracted from the communication data, i.e., the start point appliance address (the appliance address and the port number of the transmission-side communication apparatus 3a), the end point appliance address (the appliance address and the port number of the reception-side communication apparatus 3b), and the protocol to determine an associated communication method (action; S2002). If the action of the determination result is “pass”, the data communication execution start processing is terminated, and then data communication processing (S3000) is executed.

Also, if the determination result is “discard”, the data communication execution start processing is terminated. Furthermore, if the determination result is “encryption”, the encrypted communication selecting section 18 requests the encrypted communication section 16 to conduct an encrypted communication of the communication data, and the encrypted communication section 16 retrieves encrypted communication information of the communication from the encrypted communication information database 17 (S2003). That is, the encrypted communication section 16 retrieves encrypted communication information matching respective data extracted from the communication data, namely, the communication source address (the appliance address and the port number of the transmission-side communication apparatus 3a) and the communication destination address (the appliance address and the port number of the reception-side communication apparatus 3b). If the encrypted communication information is absent, the encrypted communication section 16 requests the connection control section 14 of the transmission-side adaptor 1a to conduct the setting to obtain encrypted communication information, and the connection control section 14 transmits, from the communication control section 11 via the communication medium 5 to the access managing server device 4, a connection communication apparatus retrieval request including the address information (appliance address) of the reception-side communication apparatus 3b (S2004). Incidentally, if the encrypted communication information is present in the encrypted communication information database 17, the transmission-side adaptor 1a terminates the data communication execution start processing and then executes the data communication processing (S3000).

According to the address information of the reception-side adaptor 1b included in the connection communication apparatus retrieval request, the access managing server device 4 retrieves address information of the reception-side adaptor 1b related (connected) to the communication apparatus 3b from connection management database (S2005) If the matching address information is absent as a result, the access managing server device 4 assumes that the connection destination is unknown and returns information indicating that the connection destination is unknown to the transmission-side adaptor 1a. When the information indicating that the connection destination is unknown is received, the connection control section 14 of the transmission-side adaptor 1a executes processing, for example, processing to display, on the output unit 96 of the transmission-side adaptor 1a, a message indicating that the connection destination of the access managing server device 4 is unknown, and terminates the data communication execution start processing. On the other hand, if the matching reception-side adaptor 1b is present, identifying information of the matching reception-side adaptor 1b is returned to the transmission-side adaptor 1a (S2006). The identifying information used here is, for example, Uniform Resource Identifiers (URI) to identify the adaptor 1.

The connection control section 14 of the transmission-side adaptor 1a transmits connection instruction information indicating the connection to the reception-side adaptor 1b from the communication control section 11 via the communication medium 5 to the access managing server device 4 (S2007). Here, the connection instruction information includes identifying information of the reception-side adaptor 1b as the connection destination, address information of the peer-to-peer communication of the transmission-side adaptor 1a, address information of the transmission-side communication apparatus 3a, address information of the reception-side communication apparatus 3b, a protocol of the peer-to-peer communication, and encrypted communication information. Also, the peer-to-peer communication information includes the encryption type 110 and the authentication type 111 included in the connection policy information used to determine the connection method (policy) and the respective key information, namely, algorithm information and key information which are shared for the encrypted communication (peer-to-peer communication) between the adaptors.

The access managing server device 4 allocates an identifier (connection ID) to the connection between the adaptors indicated by the connection indication information to register the identifier together with the identifying information of the adaptors to the connection managing database and adds the connection ID to the connection instruction information to transmit (transfer) the information to the reception-side adaptor 1b corresponding to the identifying information of the apparatus included in the connection instruction information (S2008).

In the reception-side adaptor 1b, the connection control section 14 retrieves, from the connection policy database 15 held by the reception-side adaptor 1b, connection policy information matching respective data of the start point appliance address (the appliance address of the transmission-side communication apparatus 3a), the end point appliance address (the appliance address of the reception-side communication apparatus 3b), and the protocol extracted form the connection instruction information to determine an associated communication method (action; S2009).

If the action of the determination result is other than “encryption”, namely, “pass” or “discard”, the connection policy is mismatching between the adaptors, and hence the connection control section 14 of the reception-side adaptor 1b returns information indicating non-connectibility via the access managing server device 4 to the transmission-side adaptor 1a. When the non-connectibility information is received, the connection control section 14 of the transmission-side adaptor 1a executes processing such as processing to display on the output unit 96 of the transmission-side adaptor 1a a message indicating the non-connectibility with respect to the access managing server device 4 and then terminates the data communication execution start processing.

On the other hand, if the determination result is “encryption” and the encryption type 110 and the authentication type 111 included in the connection policy information match those of the encrypted communication information included in the connection instruction information, the connection control section 14 of the reception-side adaptor 1b records the encrypted communication information included in the connection instruction information in the encrypted communication information database 17. That is, the connection control section 14 creates a new entry in the encrypted communication information database 17, records the connection ID, the address information of the transmission-side adaptor 1a, the address information of the transmission-side communication apparatus 3a, the address information of the reception-side communication apparatus 3b, and the key information of the encrypted communication information included in the connection allowance information respectively in the items of the connection ID 201, the adaptor address 203 (IP address 204, port number 205), the communication source address 206 (IP address 207, port number 208), the communication destination address 209 (IP address 210, port number 211), and the encryption key 212 (for communication 213, for authentication 214) of the encrypted communication information database 17; and records the policy ID 101 as the identifying information to identify the connection policy information in the connection policy database 15 in the applied policy 202 of the encrypted communication information database 17.

The connection control section 14 creates the connection allowance information to allow the connection of communication via the transmission-side adaptor 1a to the transmission-side communication apparatus 3a, that is, communication between the transmission-side communication apparatus 3a and the reception-side communication apparatus 3b via the adaptors (S2011) and transmits the connection allowance information from the communication control section 11 via the communication medium 5 to the access managing server device 4 (S2012). Here, the connection allowance information includes the connection ID, the identifying information of the reception-side adaptor 1b, the communication address information of the transmission-side adaptor 1a, the address information of the transmission-side communication apparatus 3a, the address information of the reception-side communication apparatus 3b, and the protocol of the peer-to-peer communication included in the connection instruction information; moreover, the encrypted communication information from the transmission-side adaptor 1a and the communication address information of the reception-side adaptor 1b.

Incidentally, if the encrypted communication information included in the connection instruction information does not match that of the connection instruction information, the connection control section 14 of the reception-side adaptor 1b returns information indicating non-communicability via the access managing server device 4 to the transmission-side adaptor 1a. When the non-communicability information is received, the connection control section 14 of the reception-side adaptor 1b executes processing, for example, processing to display, on the output unit 96 of the transmission-side adaptor 1a, a message of the non-communicability with the access managing server device 4, and terminates the data communication execution start processing.

The access managing server device 4 returns (transfers) the connection allowance information received from the reception-side adaptor 1b to the transmission-side adaptor 1a as the transmission source of the connection instruction information (S2013). When the connection allowance information is received, the connection control section 14 of the transmission-side adaptor 1a stores the encryption information included in the connection allowance information in the encrypted communication information database 17 (S2014).

That is, the connection control section 14 creates a new entry in the encrypted communication information database 17, records the connection ID, the address information of the reception-side adaptor 1b, the address information of the transmission-side communication apparatus 3a, the address information of the reception-side communication apparatus 3b, and the key information of the encrypted communication information included in the connection allowance information respectively in the items of the connection ID 201, the adaptor address 203 (IP address 204, port number 205), the communication source address 206 (IP address 207, port number 208), the communication destination address 209 (IP address 210, port number 211), and the encryption key 212 (for communication 213, for authentication 214) of the encrypted communication information database 17; and records the policy ID 101 as the identifying information to identify the connection policy information in the connection policy database 15 in the applied policy 202 of the encrypted communication information database 17, the connection policy information being extracted in the communication method determination in step S2002.

Incidentally, in the data communication execution start processing, the connection control section 14 of the transmission-side adaptor 1a creates the encryption key information (the communication shared key corresponding to the encryption type, the message authentication shared key corresponding to the authentication type) as the encrypted communication information of the peer-to-peer communication and transmits the connection instruction information including the encryption key information to the reception-side adaptor 1b in step S2007 to thereby share the encryption key information of the peer-to-peer communication between the adaptors. However, it is also possible that the encryption key information is included in the connection allowance information created by the reception-side adaptor 1b to return the connection allowance information via the access managing server device 4 to the transmission-side adaptor 1a in step S2012 to thereby share the encryption key information.

Or, it is possible that the encryption key information is not included in the connection instruction information and the access managing server device 4 to relay the connection instruction information creates encryption key information based on the encryption type and the authentication type included in the connection instruction information, adds the encryption key information to the connection instruction information and the connection allowance information as a response thereto, and transmits the connection instruction information and the connection allowance information respectively to the reception-side adaptor 1b and the transmission-side adaptor 1a in step S2008 to thereby share the encryption key information between the adaptors.

Also, it is possible that the encryption key information to be notified or exchanged by use of the connection instruction information or the connection allowance information is not the encryption key itself, but is information (seed information) as a seed to create an encryption key. In this case, the adaptor creates an encryption key by use of the received seed information. For example, the reception-side adaptor 1b creates an encryption key in step S2011 and the transmission-side adaptor 1a creates an encryption key in step S2014.

Also, in the data communication execution start processing, when the transmission-side adaptor 1a issues a connection instruction to the reception-side adaptor 1b, the transmission-side adaptor 1a obtains identifying information of the reception-side adaptor 1b in the processing procedure in steps S2004 to S2007 and the transmission-side adaptor 1a notifies connection instruction information to the transmission-side adaptor 1a in the processing procedure in steps S2004 to S2007. However, the identifying information acquisition and the connection indication may also be simultaneously carried out.

In this case, in the data communication execution start processing, the transmission-side adaptor 1a transmits, after the processing of steps S2001 and S2002, connection instruction information including the appliance address of the reception-side communication apparatus 3b to the access managing server device 4 (corresponding to processing of steps S2004 and S2007). According to the address information of the reception-side communication apparatus 3b included in the connection instruction information from the transmission-side adaptor 1a, the access managing server device 4 retrieves, from the connection managing database, address information of the reception-side adaptor 1b related to the reception-side communication apparatus 3b and transmits the connection instruction information to the associated reception-side adaptor 1b (corresponding to processing of steps S2005 and S2008). Thereafter, processing of steps 2009 to S2014 is executed.

Incidentally, in the data communication execution start processing, it is also possible to set the duration (effective period) to the encrypted communication information of the peer-to-peer communication, the information being notified and shared between the adaptors. In this case, in the processing of steps S2011 and S2014 in which the adaptor 1 records the encrypted communication information in the encrypted communication information database 17, the duration of the encrypted communication included in the encrypted communication information is registered to the duration 207 of the encrypted communication information database 17. By setting the duration in the encrypted communication information, the encryption key used in the encrypted communication can be changed at a fixed interval of time, and hence safety of the encrypted communication can be increased.

Incidentally, the communication instruction information transmitted by the access managing server device 4 and the adaptors 1 (the transmission-side adaptor 1a, the reception-side adaptor 1b) correspond to an INVITE request in the SIP.

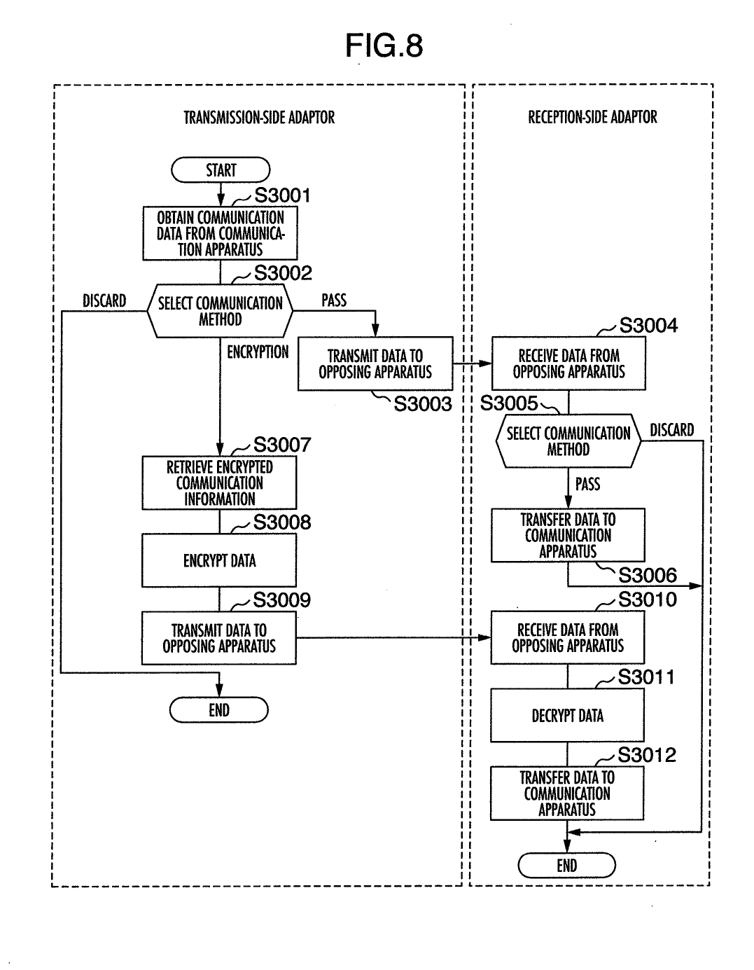

FIG. 8 shows a flowchart of processing executed in the data communication processing (S3000). When the transmission-side communication apparatus 3a connected to the transmission-side adaptor 1a transmits communication data to the reception-side communication apparatus 3b (connected to the reception-side adaptor 1b), the encrypted communication selecting section 18 of the transmission-side adaptor 1a obtains the communication data via the second communication control section 12 (S3001).

The encrypted communication selecting section 18 retrieves, from the connection policy database 15 held by the transmission-side adaptor 1a, connection policy information matching with respective data of the start point appliance address (the appliance address of the transmission-side communication apparatus 3a), the end point appliance address (the appliance address of the reception-side communication apparatus 3b), and the protocol extracted form the communication data to determine an associated communication method (action; S3002).

If the action of the determination result is “encryption”, control goes to step S3007. Also, if the action of the determination result is “discard”, the data communication processing is terminated. If the action of the determination result is “pass”, the encrypted communication selecting section 18 transmits the communication data via the communication control section 11 to the reception-side adaptor 1b (S3003).

In the reception-side adaptor 1a, the encrypted communication selecting section 18 obtains the communication data via the communication control section 11 (S3004), retrieves, from the connection policy database 15 held by the reception-side adaptor 1b, connection policy information matching with respective data of the start point appliance address (the appliance address of the transmission-side communication apparatus 3a), the end point appliance address (the appliance address of the reception-side communication apparatus 3b), and the protocol extracted form the communication data to determine an associated communication method (action; S3005).

If the action of the determination result is “discard”, the received communication data is invalid and hence the data communication processing is terminated. Also, if the action of the determination result is “encryption”, the received communication data for which the encryption processing has not been executed is invalid and hence the data communication processing is terminated. If the action of the determination result is “pass”, the encrypted communication selecting section 18 transmits the received communication data to the reception-side communication apparatus 3b connected via the second communication control section 12 to the reception-side adaptor 1b (S3006). Resultantly, the reception-side communication apparatus 3b can receive the communication data transmitted from the transmission-side communication apparatus 3a.

On the other hand, if it is determined in step S3002 that the action of the connection policy corresponding to the communication data is “encryption”, the encrypted communication selecting section 18 requests the encrypted communication section 16 to conduct the encrypted communication of the communication data, and the encrypted communication section 16 retrieves encrypted communication information of the communication from the encrypted communication information database 17 (S3007).

That is, the encrypted communication section 16 retrieves encrypted communication information matching the respective data of the communication source address (the appliance address and the port number of the transmission-side communication apparatus 3a) and the communication destination address (the appliance address and the port number of the reception-side communication apparatus 3b) extracted from the communication data. If the encrypted communication information is present, the encrypted communication section 16 encrypts, according to the encryption key information included in the encrypted communication information, the communication data from the transmission-side communication apparatus 3a (S3008) and transmits the communication data to the reception-side adaptor 1b (S3009). Incidentally, if the encrypted communication information is absent from the encrypted communication information database 17, the data communication execution start processing (S2000) is executed.

In the reception-side adaptor 1b, the encrypted communication section 16 obtains the communication data via the communication control section 11 (S3010) and retrieves encrypted communication information in the communication from the encrypted communication information database 17.

That is, the encrypted communication section 16 retrieves encrypted communication information matching the respective data of the communication source address (the appliance address and the port number of the transmission-side communication apparatus 3a) and the communication destination address (the appliance address and the port number of the reception-side communication apparatus 3b) extracted from the communication data. If the encrypted communication information is present, the encrypted communication section 16 decrypts, according to the encryption key information included in the encrypted communication information, the communication data received from the transmission-side adaptor 1a (S3011) and transmits the communication data to the reception-side communication apparatus 3b (S3012). Incidentally, if the encrypted communication information is absent from the encrypted communication information database 17, the encrypted communication data thus received is invalid and the data communication execution start processing is terminated.

Incidentally, if the duration (effective period) has been set to the encrypted communication information of the peer-to-peer communication, the time when the encrypted communication section 16 of the transmission-side adaptor 1a or the reception-side adaptor 1b executes the encryption processing or the decryption processing is assumed as the last communication time and is recorded in the last communication time 216 of the pertinent encrypted communication information in the data communication processing. That is, the last communication time 216 in the encrypted communication information database 17 is updated respectively in the encryption processing by the encrypted communication section 16 of the transmission-side adaptor 1a in step S3008 and the decryption processing by the encrypted communication section 16 of the reception-side adaptor 1b in step S3011.

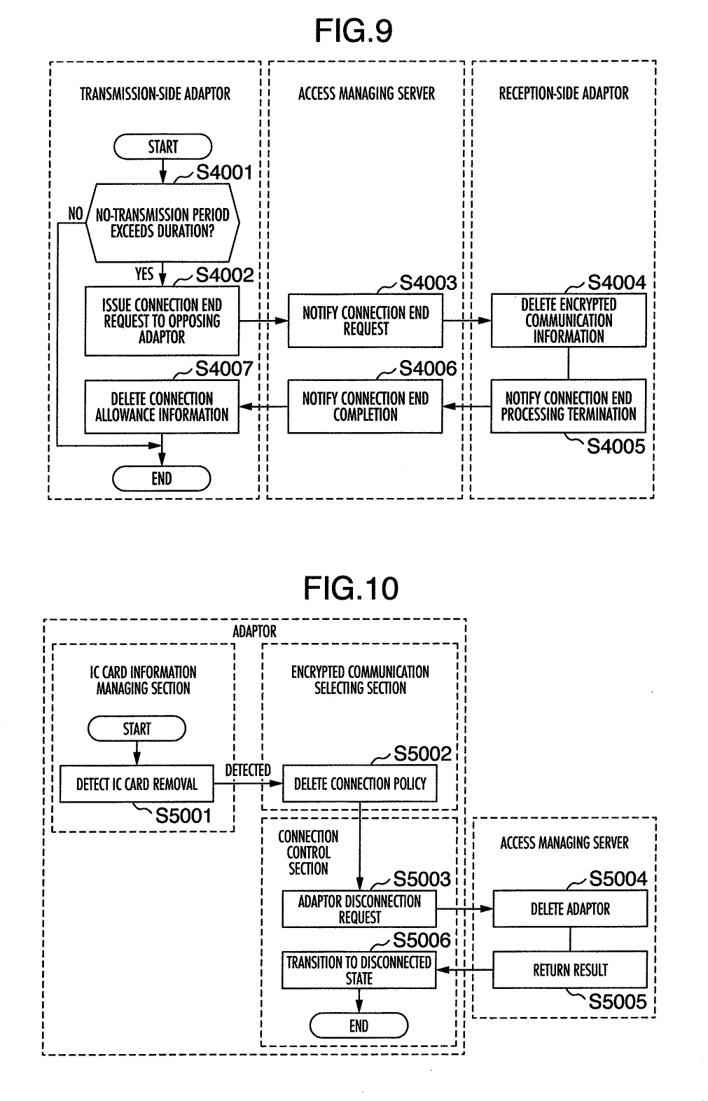

FIG. 9 shows a flowchart of processing executed in the data communication end processing (S4000). Incidentally, if the duration (effective period) has not been set to the encrypted communication information of the peer-to-peer communication, the data communication end processing is not executed.

The encrypted communication section 16 of the transmission-side adaptor 1a checks, at a fixed interval of time, the duration 215 and the last communication time 216 of the encrypted communication information recorded in the encrypted communication information database 17 to detect encrypted communication information in which the difference between the present time and the last communication time 216 exceeds the duration 215 (S4001). Furthermore, if the pertinent encrypted communication information is not detected, the data communication end processing is terminated. Also, if the pertinent encrypted communication information is detected, the encrypted communication section 16 requests the connection control section 14 to terminate the encrypted communication, namely, to invalidate the encrypted communication information, and the connection control section 14 transmits a connection end request from the communication control section 11 via the communication medium 5 to the access managing server device 4 (S4002). Here, the connection end request includes a connection ID (recorded in the connection ID 201 of the encrypted communication information database 17) as an identifier to identify the connection between the adaptors.

The access managing server device 4 retrieves a reception-side adaptor 1b from the connection managing database using the connection ID included in the connection end request to transmit (transfer) the connection end request to the reception-side adaptor 1b (S4003). In the reception-side adaptor 1b, the connection control section 14 retrieves, from the encrypted communication information database 17 of the reception-side adaptor 1b, encrypted communication information matching the connection ID extracted from the connection end request. If the encrypted communication information is present, the encrypted communication information is deleted from the encrypted communication information database 17 (S4004) and the deletion completion is transmitted as a connection end processing completion notification to the access managing server device 4 (S4005).

The access managing server device 4 deletes the connection information between adaptors identified by the connection ID from the connection managing database and returns (transfers) the connection end processing completion notification received from the reception-side adaptor 1b to the transmission-side adaptor 1a as the transmission source of the connection end request (S4006).

When the connection end processing completion notification is received, the connection control section 14 of the transmission-side adaptor 1a deletes the encrypted communication information as the connection end target, i.e., the encryption information detected in step S4001 from the encrypted communication information database 17 (S4007).

Incidentally, the connection end information transmitted by the access managing server device 4 and the adaptors 1 (the transmission-side adaptor 1a in the data communication end processing, the reception-side adaptor 1b) corresponds to a BYE request in the SIP.

FIG. 10 shows a flowchart of processing executed in the apparatus access end processing (S5000). In the processing, when the IC card 2 is removed from the IC card reader unit 98 of the adaptor 1, the secure communication processing in the adaptor 1 is terminated to thereby guarantee the encrypted communication unified with the authentication by the IC card.

The IC card information managing section 13 of the adaptor 1 detects the removal of the IC card 2 from the IC card reader unit 98 installed in the adaptor 1 and notifies the detection to the encrypted communication selecting section 18 (S5001). The encrypted communication selecting section 18 deletes the connection policy information stored in the connection policy database 15 (S5002). Next, the encrypted communication selecting section 18 requests the connection control section 14 of the adaptor 1 to delete the apparatus connection, and the connection control section 14 creates an apparatus deletion request including the address information (appliance address) of the adaptor 1 and transmits the apparatus deletion request to the access managing server device 4 (S5003).

The access managing server device 4 deletes from the connection managing database the address information corresponding to the adaptor 1 included in the apparatus deletion request (S5004) and returns information indicting deletion success to the adaptor 1 (S5005). After the deletion success information is received, the connection control section 14 of the adaptor 1 makes a transition to the disconnected state (S5006). That is, the adaptor 1 enters a state to wait for reception of an apparatus connection request from the encrypted communication selecting section 18.

Incidentally, the apparatus deletion request transmitted by the access managing server device 4 and the adaptors 1 in the apparatus access end processing corresponds to a REGISTER (at registration deletion) request in the SIP.

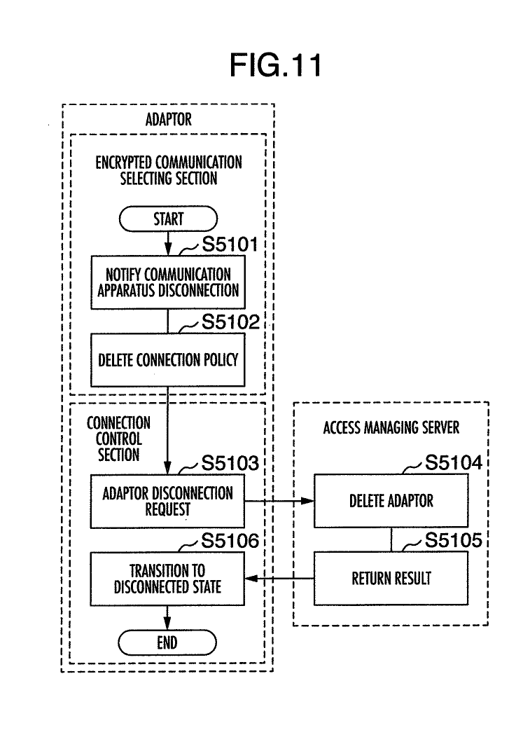

FIG. 11 shows a flowchart of processing executed in another processing (S5100) of the apparatus access end processing. In this processing, when the communication path between the adaptor 1 and the communication apparatus 3 is disconnected, the secure communication processing in the adaptor 1 is terminated to thereby prevent the pretense communication by changing the communication apparatus connected via the second communication control section 12.

The encrypted communication selecting section 18 of the adaptor 1 detects whether or not the communication to the communication apparatus 3 enters a disconnected state, for example, by the removal of a cable connecting the adapter 1 via the second communication control section 12 to the communication apparatus 3 (S5101). If the communication disconnection is detected, the encrypted communication selecting section 18 deletes the connection policy information stored in the connection policy database 15 (S5102). Next, the encrypted communication selecting section 18 requests the connection control section 14 of the adaptor 1 to delete the apparatus connection, the connection control section 14 creates an apparatus deletion request including the address information (appliance address) of the adaptor 1 and transmits the apparatus deletion request to the access managing server device 4 (S5103).

The access managing server device 4 deletes the address information corresponding to the adaptor 1 included in the apparatus deletion request from the connection managing database (S5104) and returns information indicating deletion success to the adaptor 1 (S5105). After the deletion success information is received, the connection control section 14 of the adaptor 1 makes a transition to the disconnected state (S5106). That is, the connection control section 14 enters a state to wait for reception of an apparatus connection request from the encrypted communication selecting section 18.

Through the above steps (S1000 to S5000), in a communication system connected to communication apparatuses in which the ciphered communication processing cannot be installed, there can be set for each user a security policy unified with authentication of the user, and communication can be conducted between the communication apparatuses while securing high safety.

As above, the communication data to the communication apparatus 3 always passes the adaptor 1. For data other than the encrypted data as a result of execution of the apparatus access start processing (S1000), the communication method (action) of the communication data is always determined according to the contents of the connection policy database 15, therefore it is possible to prevent an unauthorized access to the communication apparatus 3.

That is, for the communication between the communication apparatuses for which “encryption” is set as the action in the connection policy database 15 (the communication between the transmission-side communication apparatus 3a and the reception-side communication apparatus 3b shown in FIG. 2), it is required to always execute the data communication execution start processing (S2000), and hence only the communication apparatus 3 connected to the adaptor 1 having succeeded in the IC card authentication can communicate with the opposing communication apparatus.

In a case in which the communication data is not encrypted in the communication for which “encryption” is set as the action of the connection policy, the communication data is discarded. Also, after the authentication of the IC card 2 is successfully conducted, the connection policy information to be recorded in the connection policy database 15 is obtained from the IC card 2 and is deleted therefrom when the IC card is removed, and hence there can be conducted the setting unified with the authentication for each user related to the IC card.

As a result, the setting can be conducted for each user of a communication apparatus not having ability for encryption, namely, having low processing performance, and hence there can be implemented the highly safe access.

Incidentally, in the above description, there is employed a configuration in which a single access managing server device 4 exists on the communication network providing highly safe communication, namely, a configuration in which the adaptor 1 accesses the particular access managing server device 4. However, there may also be used a configuration in which a plurality of access managing server devices 4 exist on the same communication network and a configuration in which the adaptor 1 simultaneously connects to a plurality of access managing server devices 4 or simultaneously selects and connects to a plurality of access managing server devices 4.

In the configuration in which the adaptor 1 simultaneously connects to a plurality of access managing server devices 4, user authentication information corresponding to the plural access managing server devices 4 and connection information (appliance addresses and the like) of the access managing server devices 4 are recorded in the user authentication information 21 of the IC card 2 connected to the adaptor 1, and the procedure (steps S1016 to S1019) to register an adaptor 2 to the access managing server device 4 in the procedure of the apparatus access start processing shown in FIG. 6 is executed for all access managing server devices 4 thus connected.

Next, the connection communication apparatus retrieval procedure (steps S2004 to S2007) of the procedure of the data communication execution start processing shown in FIG. 7 is executed for all connected access managing server devices 4 to determine the access managing server devices 4 for which the connection destination is not unknown, and the subsequent steps are conducted for the access managing server devices 4.

Moreover, the procedure (steps S5003 to S5006) to disconnect the adaptor 2 from the access managing server device 4 in the procedure of the apparatus access end processing shown in FIG. 10 is executed for all connected access managing server devices 4.

Also, in the configuration in which the adaptor selects and connects to a plurality of access managing server devices 4, like in the case of the simultaneous connection, the user authentication information corresponding to the plural access managing server devices 4 and the connection information (appliance addresses and the like) of the access managing server devices 4 are recorded in the user authentication information 21 of the IC card 2 connected to the adaptor 1, and hence it is possible in the registration procedure (step S1019) of registering an adaptor 2 to the access managing server device 4 in the procedure of the apparatus access start processing shown in FIG. 6 to select, by an input from the input unit 95 of the adaptor 1 or the communication apparatus 3 connected to the adaptor 1, the access managing server devices 4 to be connected.

Also, the user information to access the user authentication information corresponding to a plurality of access managing server devices 4 recorded in the user authentication information 21 of the IC card 2 is not necessarily one single user information piece. It is also possible that each user authentication information, namely, the user information corresponding to each access managing server device is recorded in the user authentication information 20 of the IC card 2. To the IC card user information obtaining procedure (step S1007) of the apparatus access start processing in FIG. 6, a procedure to present and to select information of the access managing server devices corresponding to the stored user information is added so that the adaptor 1 selects the access managing server devices 4 to be connected thereto.

As a result, if there have been prepared the communication apparatuses 3 connected to the adaptor 2, it is possible for the user to implement the highly safe access by use of the communication policy which can be set for each user.

Incidentally, in the configuration in which a plurality of access managing server devices 4 exist on the same network as described above, by recording the connection policy information corresponding to each access managing server device in the connection policy information 22 of the IC card 2, the policy may be changed for each access managing server device 4 to be connected.

In this case, in the connection policy request processing (step S1012) of the procedure of the apparatus access start processing in FIG. 6, the connection policy information corresponding to the access managing server device 4 to be connected is obtained from the connection policy information 22 of the IC card 2.

The present invention is applied to a system in which an electric appliance and/or a family electric appliance connected to a home network is controlled by use of an outdoor appliance from an outdoor place. The present invention is usable, for example, in a large-capacity data communication service in which a DVD/HDD recorder in a house is controlled from an outdoor place, for example, to download contents accumulated therein to an outdoor appliance and for the energy saving and the home security and in an remote appliance control service in which family electric appliances such as an air conditioner, a lighting apparatus, and an electric lock are controlled from an outdoor place. Also, in a system of a firm, the present invention is usable for a remote office service in which a Web server or the like is accessed from a place outside the firm and against the information leakage in the in-house network of the firm. Also, to implement such services and the like, the present invention is suitable to increase safety by preventing the unauthorized access.

It should be further understood by those skilled in the art that although the foregoing description has been made on embodiments of the invention, the invention is not limited thereto and various changes and modifications may be made without departing from the spirit of the invention and the scope of the appended claims.

1. An adaptor connected to a network to conduct encrypted communication, comprising:
a storage section for storing connection policy information to determine a communication method between a first communication apparatus directly connected to the adaptor and a second communication apparatus connected to the network;
a communication selecting section for determining, by use of the connection policy information, a communication method of communication from the first communication apparatus to the second communication apparatus;
an encrypted communication section for encrypting, if the communication selecting section determines encrypted communication, communication data received from the first communication apparatus and transmits the encrypted communication data to the second communication apparatus; and
an external storage medium information reader section for reading information recorded in an external storage medium, wherein
a communication policy between communication apparatuses may be set unified with authentication of the user by using the connection policy information for each user related to the external storage medium.

2. An adaptor connected to a network to conduct encrypted communication, comprising:
a storage section for storing connection policy information to determine a communication method between a first communication apparatus directly connected to the adaptor and a second communication apparatus connected to the network;
a communication selecting section for determining a communication method of communication from the first communication apparatus to the second communication apparatus by use of the connection policy information;
an encrypted communication section for encrypting, if the communication selecting section determines encrypted communication, communication data received from the first communication apparatus and transmits the encrypted communication data to the second communication apparatus;
an external storage medium information reader section for reading information recorded in an external storage medium; and
an external information control section for obtaining, when connection of the external storage medium is detected, access allowance to the external storage medium, obtaining thereafter the connection policy information stored in the external storage medium from the external storage medium information reader section, and storing the connection policy information in the storage section.

3. An adaptor according to claim 1, wherein the connection policy information is information to determine communicability between the first communication apparatus and an opposing communication apparatus and includes items of a policy ID, an action, a start point appliance address, an end point appliance address, an encryption type, and an authentication type.

4. An adaptor according to claim 1, wherein:
the communication selecting section determines a communication method of communication from the second communication apparatus to the first communication apparatus by use of the connection policy information; and
the encrypted communication section discards the communication data if the communication selecting section determines encrypted communication, if communication data received from the second communication apparatus has not been encrypted, or if the communication data cannot be appropriately decrypted.

5. An adaptor according to claim 1, wherein
the external information control section deletes the connection policy information stored in the storage section if disconnection of the connection of the external storage medium is detected.

6. An adaptor according to claim 5, comprising
a connection control section for registering the adaptor to an access managing apparatus connected to the network, wherein
the connection control section conducts the registration to the access managing apparatus if connection of the external storage medium is detected.

7. An adaptor according to claim 6, comprising
a connection control section for registering the adaptor to an access managing apparatus connected to the network, wherein
the connection control section conducts deletion of registration from the access managing apparatus if disconnection of the external storage medium is detected.

8. An adaptor according to claim 6, wherein
the connection control section uses, as authentication information to register to the access managing apparatus, authentication information stored in the external storage medium.

9. An IC card connectible to an adaptor, wherein
user information, user authentication information, and connection policy information are stored in a memory device in the IC card, and the connection policy information may be read therefrom after access allowance for access to the IC card is obtained by use of the user information.

10. An IC card according to claim 9, wherein the connection policy information is information to determine communicability between a communication apparatus connected to the adaptor and an opposing communication apparatus and includes items of a policy ID, an action, a start point appliance address, an end point appliance address, an encryption type, and an authentication type.

11. An adaptor according to claim 2, wherein the connection policy information is information to determine communicability between a communication apparatus connected to the adaptor and an opposing communication apparatus and includes items of a policy ID, an action, a start point appliance address, an end point appliance address, an encryption type, and an authentication type.

12. An adaptor according to claim 2, wherein:
the communication selecting section determines a communication method of communication from the second communication apparatus to the first communication apparatus by use of the connection policy information; and
the encrypted communication section discards the communication data if the communication selecting section determines encrypted communication, if communication data received from the second communication apparatus has not been encrypted, or if the communication data cannot be appropriately decrypted.

13. An adaptor according to claim 2, wherein
the external information control section deletes the connection policy information stored in the storage section if disconnection of the connection of the external storage medium is detected.

14. An adaptor according to claim 13, comprising
a connection control section for registering the adaptor to an access managing apparatus connected to the network, wherein
the connection control section conducts the registration to the access managing apparatus if connection of the external storage medium is detected.

15. An adaptor according to claim 14, comprising
a connection control section for registering the adaptor to an access managing apparatus connected to the network, wherein
the connection control section conducts deletion of registration from the access managing apparatus if disconnection of the external storage medium is detected.

16. An adaptor according to claim 14, wherein
the connection control section uses, as authentication information to register to the access managing apparatus, authentication information stored in the external storage medium.
